(19) United States
(12) Patent Application Publication
(10) Pub. No.: US 2005/0238960 A1
(43) Pub. Date: Oct. 27, 2005

(54) Non-sintered type positive electrode and alkaline storage battery using the same

(76) Inventors: Yasushi Nakamura, Fujisawa-shi (JP); Haruya Nakai, Fujisawa-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/995,149

(22) Filed: Nov. 24, 2004

(30) Foreign Application Priority Data
Apr. 22, 2004 (JP) 2004-126642

(51) Int. Cl. H01M 4/32; H01M 4/62

(52) U.S. Cl. 429/223; 429/232; 252/182.1

(57) ABSTRACT

The present invention provides a non-sintered type positive electrode for alkaline storage battery whose drop out of active material powder is suppressed while maintaining favorable charging-discharging properties such as utilization factor. A non-sintered type positive electrode constituted by an electrically conductive support, a nickel hydroxide powder coated by cobalt oxyhydroxide (COH), an additive made of COH powder, and a binder, in which the average particle size of the nickel hydroxide powder coated by COH is greater than that of the additive made of COH powder.

### FIELD OF THE INVENTION

The present invention relates to a non-sintered type positive electrode and an alkaline storage battery using the same.

### BACKGROUND OF THE INVENTION

Positive electrodes for use in alkaline storage batteries can be roughly divided into sintered type and non-sintered type positive electrodes. Sintered type positive electrodes are produced by: impregnating a porous sintered substrate of nickel having a porosity of about 80%, which is obtained by sintering nickel powder, with a solution of nickel salt such as aqueous nickel nitrate solution; and then immersing the resulting product in an alkaline aqueous solution and the like, thereby allowing nickel hydroxide active material in the porous nickel sintered substrate. Since the pore diameter of the nickel skeleton of the sintered positive electrode is as small as about 10 μm, the sintered positive electrode maintains relatively high retention force for active material, and can work sufficiently as a collector.

As non-sintered type positive electrodes, on the other hand, widely known are those obtained by filling nickel hydroxide powder as an active material in the three-dimensionally entrained pores of a foamed porous substrate made from metallic nickel and having a porosity of 95% or higher.

Furthermore, non-sintered types can provide positive electrodes with higher capacity than the sintered types, because the porosity of the substrates used in the non-sintered type positive electrodes is comparatively higher than that of the substrate used in the sintered type positive electrode. In order to take advantage of these characteristics, Japanese Patent Laid-Open No. S60-131765 discloses using spherical nickel hydroxide powder as the nickel hydroxide powder to be filled in the substrate, because it is easier to increase the packing density.

As the nickel hydroxide powder for use in the non-sintered type positive electrode for alkaline storage battery, pure nickel hydroxide is rarely used, and generally employed is nickel hydroxide containing cobalt, zinc, magnesium, manganese, rare earth elements, and the like.

The pore diameter of the vacancies in the nickel skeletons of a non-sintered type positive electrode substrate is relatively large in a range of about 200 to 500 μm. Accordingly, nickel hydroxide powder can be directly packed without employing the method of precipitating nickel hydroxide inside the pores as is the case for sintered type electrodes. On the other hand, when compared with sintered types, it suffers fundamental problems of inferior collectivity and thereby, of not being capable of achieving sufficiently high utilization factor in case nickel hydroxide powder alone is filled.

In order to overcome the problem above, i.e., to increase the collectivity among the powder particles and between powder particles and nickel skeletons, studies have been made on a method of using cobalt compound powder as an electrically conductive agent. In particular, the method of using divalent cobalt compounds, such as cobalt hydroxide or cobalt oxide, has been well-known for long. This method comprises oxidizing the divalent cobalt compounds added to the positive electrode in the initial charging just after assembling the battery, thereby converting them into trivalent cobalt compounds having higher electric conductivity to improve the collecting performance of the electrode.

To further increase the electric conductivity of the cobalt compounds, there is known a method of oxidizing cobalt compounds in advance. For instance, there is known a method comprising adding an alkaline aqueous solution to the cobalt hydroxide powder, and applying heating and drying thereto in the presence of oxygen, thereby converting it into a powder of cobalt oxyhydroxide (which is referenced hereinafter as “COH”). The COH powder thus obtained is higher in electric conductivity than a cobalt compound obtained by oxidization inside a battery, and thereby it can be used as a superior electrically conductive agent. An example of such a case is disclosed in Japanese Patent Laid-Open No. H09-259888.

It is necessary to increase the dispersibility to further improve the effect of COH having high electric conductivity. Recently, accordingly, there is known a method of using nickel hydroxide powder previously coated by COH. More specifically, nickel hydroxide particles coated by cobalt hydroxide are prepared first. Then, an alkaline aqueous solution is added thereto, where heating and drying is applied in the presence of oxygen to obtain nickel hydroxide particles coated by COH. An example of this method is disclosed in Japanese Patent Laid-Open No. H11-097008.

The active material prepared in the manner above exhibits high collectivity because COH is uniformly arranged around the nickel hydroxide particles, and is suitable for use as a material of high capacity alkaline storage batteries.

The method using COH powder as an electrically conductive agent (which is referenced hereinafter as “first method”) and the method using nickel hydroxide powder coated by COH in advance (which is referenced hereinafter as “second method”) each have advantages and disadvantages conflicting to each other.

More specifically, the first method enables obtaining relatively high collectivity (i.e., relatively high utilization factor) at a lower cost as compared with the second method, because nickel hydroxide particles need not be covered with COH in advance.

On the other hand, in the first method, it is difficult to uniformly disperse COH powder which functions as an electrically conductive agent with nickel hydroxide powder, and hence, the first method tends to yield somewhat lower utilization factor as compared with the second method.

As described above, the first method enables obtaining relatively favorable collective performance at a low cost, but the collectivity performance is somewhat inferior to the latter. In other words, the second method enables obtaining excellent collector performance, but at higher cost.

By taking these characteristics into consideration, the two methods above are used time to time depending on conditions. That is, in usages where cost plays an important role and where somewhat low utilization factor is allowed, the first method is employed.

On the other hand, where utilization factor is important and where an increase in price is allowed, the second method is adopted.

Recently in the second method, the production cost is reduced because of mass production effect and the like, and this method is becoming the main technique.

However, although the non-sintered type positive electrodes above enabled positive electrodes with higher capacity as compared with sintered ones, there still remained a problem to be overcome: the active material easily drops out. The reason for this problem is as follows.

The active material and the electrically conductive agent are apt to drop out, due to reasons such that the active material and the electrically conductive agent are in the powder form (i.e., in particles); the retention force for active material is insufficient as compared with a sintered positive electrode, because the pore diameter of the vacancies in the nickel skeleton is larger; and the like.

Accordingly, there are cases in which the active material drops out during construction of the battery as to provide a cause of internal short circuit. Furthermore, although there seems to have no problem just after manufacturing the battery, there are cases in which problems generate due to drop out of the active material on repeating charging and discharging, thereby generating problems such as an increase in the number of internal short circuits and self discharges.

Furthermore, in case spherical nickel hydroxide is used as the active material, particularly, dropout of active material more likely occurs because the fluidity of the particles becomes high. Presumably, the particles easily roll out without any obstacles, and this is believed to be the reason for the drop out.

In order to prevent drop out of the active material, in general, a binder is used for the non-sintered type positive electrode. This prevents drop out by adhering particles of the active material with each other using a binder. However, prevention of drop out using binders is found to be not always satisfactory.

Furthermore, in case the amount of binder is increased with the purpose of preventing drop out, the binders sometimes cover the particles of the active materials as to negatively influence the charging-discharging characteristics. Moreover, the volume of the binders not contributing in the electrochemical reaction sometimes became non-negligibly large as to cause a drop in capacity.

The present invention provides solution to the problems above, and provides a positive electrode free of drop out of active materials, while maintaining high charging-discharging characteristics such as utilization factor.

### SUMMARY OF THE INVENTION

The present invention provides a non-sintered type positive electrode for alkaline storage battery, characterized in that it comprises an electrically conductive support, a nickel hydroxide powder coated by cobalt oxyhydroxide, an additive made of cobalt oxyhydroxide powder, and a binder, in which the average particle diameter of the nickel hydroxide powder coated by cobalt oxyhydroxide is greater than that of the additive made of cobalt oxyhydroxide powder.

Furthermore, the present invention provides an alkaline storage battery comprising a negative electrode, a separator, an electrolytic solution, and a non-sintered type positive electrode characterized in that it comprises an electrically conductive support, a nickel hydroxide powder coated by cobalt oxyhydroxide, an additive made of cobalt oxyhydroxide powder, and a binder, in which the average particle diameter of the nickel hydroxide powder coated by cobalt oxyhydroxide is greater than that of the additive made of cobalt oxyhydroxide powder.

### RRIEF DESCRIPTION OF THE DRAWINGS

FIG. 1 is a cross section view of electrode A according to an embodiment of the present invention;

FIG. 2 is a cross section view of electrode B according to a comparative example; and

FIG. 3 is a cross section view of electrode C according to another comparative example.

FIG. 4 is a partially sectional view of an alkaline storage battery according to an embodiment of the present invention.

### EXPLANATION OF THE REFERENCE SYMBOLS IN THE DRAWINGS

1 Nickel hydroxide.
2 Cobalt oxyhydroxide coating nickel hydroxide.
3 Cobalt oxyhydroxide of additive agent.
4 Binder.
10 Positive electrode
20 Negative electrode
30 Separator comprising electrolytic solution
40 Battery casing

### DETAILED DESCRIPTION OF THE PREFERRED EMBODIMENTS

The present invention provides a non-sintered type positive electrode for alkaline storage battery, comprising an electrically conductive support, a nickel hydroxide powder coated by COH, an additive made of COH powder, and a binder, in which the average particle diameter of the nickel hydroxide powder coated by COH is greater than that of the additive made of COH powder. By this constitution, the additive made of COH powder is incorporated in the interstices of the nickel hydroxide powder as to establish adhesion in the form of nickel hydroxide powder-COH powder-nickel hydroxide powder, in addition to the adhesion of nickel hydroxide powder realized by the binder. Furthermore, because COH coating the nickel hydroxide powder and COH in the form of additive tend to agglomerate, they exhibit distinct effect on preventing drop out of active material powder and the like. By these effects, a positive electrode whose drop out of active material powder and the like is suppressed is implemented while maintaining high charging-discharging characteristics such as utilization factor and the like.

Furthermore, the present invention restricts the coverage of COH in the nickel hydroxide powder coated by COH. To maintain the charging-discharging characteristics such as utilization factor and the like, COH coverage is set to 3 to 10 wt. % of the nickel hydroxide to be coated by COH.

The present invention also specifies the amount of COH added as an additive. To further improve the effect of suppressing dropping out of the powder of active material and the like, the amount of COH added is set to 1 to 5 wt. % of nickel hydroxide to be coated by COH.

Further, the present invention restricts the particle diameter of the nickel hydroxide powder coated by COH and of the additive made of COH powder. In order to further enhance the effect of preventing dropping out, the average particle diameter of the nickel hydroxide powder coated by COH is set in a range of 7 to 15 μm, and the average particle diameter of the additive made of COH powder is set in a range of 0.5 to 5 μm.

In the present invention, the shape of the nickel hydroxide powder coated by COH is specified, such that the active material powder is spherical in shape. The effect of suppressing dropping out is particularly pronounced in case the active material powder is spherical in shape.

An example of an alkaline storage battery using the positive electrode for alkaline storage battery produced in the manner described above has a constitution as follows.

By using a positive electrode of the present invention together with a negative electrode having a layer of hydrogen-absorbing alloy powder on the surface of an electrically conductive support, and with a separator made of a polymer resin, the set of electrodes comprising the separator arranged in such a manner to insulate the positive electrode from the negative electrode, which are coiled or laminated, is inserted inside a battery casing. Then, an alkaline storage battery can be produced by injecting a predetermined amount of electrolytic solution and hermetically sealing the inlet part.

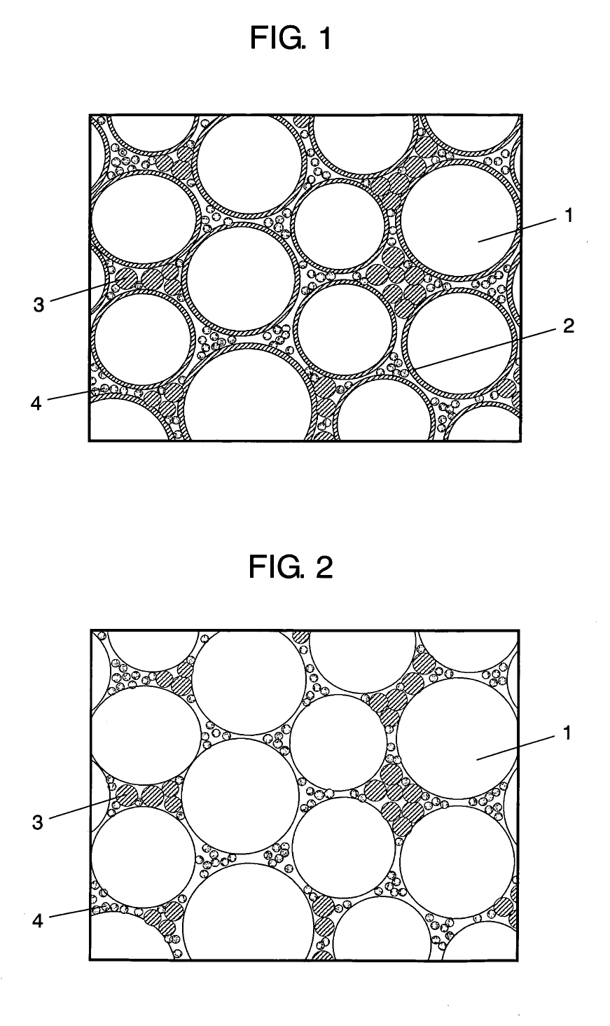

The embodiment of the present invention is described below by making reference to FIGS. 1 to 4.

It should be noted that the drawings are all drawn schematically, and the positional relation is not dimensionally accurate. Moreover, the same constitution is shown by attaching the same reference symbol.

The average particle diameter as referred herein is shown by the particle diameter (D50), at which cumulative mass of the particles smaller than the diameter accounts for 50% of the total mass of the powder. A laser diffraction particle size analyzer (MICROTRAC HRA 9320-X100 produced by Honeywell, Inc.) was used for the measurement.

An example of an alkaline storage battery according to an embodiment of the present invention is shown in FIG. 4.

### Embodiment 1

A nickel hydroxide powder coated by COH was prepared by a method as follows. First, into an aqueous solution containing nickel sulfate as the principal component with cobalt sulfate and zinc sulfate each added at predetermined quantities, aqueous solution of sodium hydroxide was gradually dropped while controlling pH of the solution using ammonia water. Precipitates of spherical nickel hydroxide were obtained in this manner. On completion of the reaction, the resulting product was rinsed with water and dried to obtain nickel hydroxide powder.

By using this nickel hydroxide as the mother particle, aqueous solution of cobalt sulfate was added thereto, and while stirring sufficiently, aqueous solution of sodium hydroxide was gradually added thereto.

In this manner, nickel hydroxide was coated by cobalt hydroxide.

The coverage of cobalt hydroxide was adjusted to 5% with respect to the weight of the mother particle nickel hydroxide. Upon completion of the reaction, the powder was rinsed with water and dried to obtain a nickel hydroxide powder coated by COH.

An aqueous solution of sodium hydroxide was added to the thus prepared nickel hydroxide coated by cobalt hydroxide. Then, while in wet state, heating and drying was applied thereto under the presence of oxygen. Cobalt hydroxide was oxidized in this manner to obtain nickel hydroxide coated by COH. The COH-coated nickel hydroxide was found to have an average particle diameter of 10.2 μm.

The COH powder was prepared in the following manner. While adjusting pH of the solution using ammonia water, an aqueous solution of cobalt sulfate was gradually added to the aqueous solution of sodium hydroxide to allow precipitation of cobalt hydroxide powder.

Then, cobalt hydroxide obtained by rinsing with water and drying was dispersed in water, and while sufficiently stirring, an aqueous solution of sodium hypochloride was added gradually thereto to prepare COH by oxidation. COH powder was thus obtained by rinsing with water and drying.

The COH thus obtained had an average particle diameter of 2.1 μm.

Then, 2 parts by weight of COH and 25 parts by weight of 3 wt % carboxymethyl cellulose (which is referenced as “CMC” hereinafter) were sufficiently mixed with 105 parts by weight of nickel hydroxide coated by COH in a mixer; further, 5 parts by weight (in solid basis) of an aqueous dispersion containing 50 wt. % of polytetrafluoroethylene (which is referenced as “PTFE” hereinafter) was mixed as a binder thereafter to obtain a paste-like product. The paste was filled inside a foamed nickel substrate, i.e., an electrode support, which was dried and rolled thereafter with a roller press. The resulting product was cut, and leads were provided thereto to obtain electrode plates. Thus was prepared positive electrode A.

FIG. 1 shows schematically drawn positive electrode A. Nickel hydroxide 1 coated by COH 2, COH 3 as an additive, and binder 4 can be observed.

The reference symbols for COH are differed depending on the function.

### COMPARATIVE EXAMPLE 1

As comparative example 1, a method for preparing positive electrode for alkaline storage battery including an electrically conductive support, nickel hydroxide powder (nickel hydroxide not coated by COH), an additive made of COH powder, and a binder, is explained.

Nickel hydroxide powder was prepared by a method comprising gradually dropping an aqueous solution of sodium hydroxide into an aqueous solution containing nickel sulfate as the principal component with cobalt sulfate and zinc sulfate each added at predetermined quantities, while controlling pH of the solution using ammonia water, to thereby obtain precipitates of spherical nickel hydroxide. The nickel hydroxide was found to have an average particle diameter of 10.1 μM.

The COH powder was prepared in the same manner as in Embodiment 1. The average particle diameter of the powder was 2.1 μm.

Seven parts by weight of COH and 25 parts by weight of 3 wt % CMC were sufficiently mixed with 100 parts by weight of nickel hydroxide in a mixer, and then, 5 parts by weight (in solid basis) of an aqueous emulsion containing 50 wt. % of PTFE was mixed therein as a binder to obtain a paste-like product. The paste was filled inside a foamed nickel substrate, i.e., an electrode support, which was dried and rolled thereafter with a roller press. The resulting product was cut, and leads were provided thereto to obtain electrode plates. Thus was prepared positive electrode B. The positive electrode B is shown schematically in FIG. 2.

### COMPARATIVE EXAMPLE 2

As comparative example 2, a method for preparing positive electrode for alkaline storage battery including an electrically conductive support, nickel hydroxide powder coated by COH, and a binder, is explained.

Nickel hydroxide powder coated by COH for use in the example was prepared by the following method in a manner similar to Embodiment 1. First, into an aqueous solution containing nickel sulfate as the principal component with cobalt sulfate and zinc sulfate each added at predetermined quantities, aqueous solution of sodium hydroxide was gradually dropped while controlling pH of the solution using ammonia water. Precipitates of spherical nickel hydroxide were obtained in this manner.

By using this nickel hydroxide as the mother particle, aqueous solution of cobalt sulfate was added thereto, and while stirring sufficiently, aqueous solution of sodium hydroxide was gradually added thereto to cover nickel hydroxide with cobalt hydroxide. The coverage of cobalt hydroxide was adjusted to 7% with respect to the weight of the mother particle nickel hydroxide.

An aqueous solution of sodium hydroxide was added to the thus prepared nickel hydroxide coated by cobalt hydroxide, and, while in wet state, heating and drying were applied thereto under the presence of oxygen. Cobalt hydroxide was oxidized in this manner to obtain COH-coated nickel hydroxide. The COH-coated nickel hydroxide was found to have an average particle diameter of 10.4 μm.

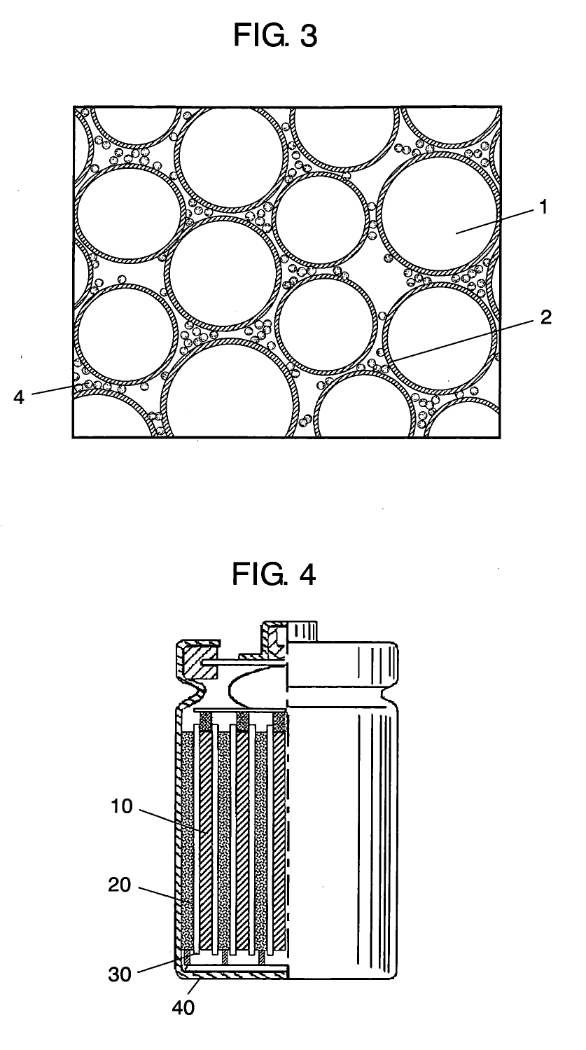

Twenty-five parts by weight of 3 wt % CMC was thoroughly mixed with 107 parts by weight of nickel hydroxide coated by COH in a mixer, and then, 5 parts by weight (in solid basis) of an aqueous emulsion containing 50 wt. % of PTFE was mixed therein as a binder to obtain a paste-like product. The paste was filled inside a foamed nickel substrate, i.e., an electrode support, which was dried and rolled thereafter with a roller press. The resulting product was cut, and leads were provided thereto to obtain electrode plates. Thus was prepared positive electrode C. The positive electrode C is shown schematically in FIG. 3.

The positive electrode thus produced, a negative electrode based on a hydrogen-absorbing alloy, and a separator made from a polypropylene non-woven cloth subjected to hydrophilic treatment, were arranged in such a manner that the positive electrode plate and the negative electrode were insulated from each other by interposing the separator, and were coiled to obtain a set of electrodes.

Thus obtained set of electrodes was inserted inside a battery casing, and an alkaline electrolytic solution containing a predetermined amount of potassium hydroxide as the principal solute together with sodium hydroxide and lithium hydroxide, making a concentration of 8 mol/L in total, was injected into the casing, and the casing was sealed. Thus was obtained an AAA size battery with a nominal capacity of 900 mAh. The batteries using positive electrode A, positive electrode B, and positive electrode C are each denoted battery A, battery B, and battery C, respectively.

Each battery was charged for 15 hours at 0.1 hour rate (90 mA), and was allowed to discharge for 40 minutes at 1 hour rate (900 mA). This cycle was repeated twice, and the batteries were each reserved at 45° C. for 3 days to activate the alloy negative electrode.

The discharge capacity was obtained in the following manner. After charging for 15 hours at 0.1 hour rate, the battery was allowed to discharge at 0.2 hour rate, 1 hour rate, and 2 hour rate until the battery voltage was reduced to 0.8 V. The charging and discharging were carried out under conditions as such that the atmosphere temperature was 20° C.

The theoretical capacity of the positive electrode represents the capacity in case nickel hydroxide is charged and discharged by single electron reaction, and is obtained by multiplying the weight of nickel hydroxide in the positive electrode active material by 289 mAh/g.

The utilization factor of the positive electrode was calculated by dividing the discharge capacity with the theoretical capacity of the positive electrode.

Further, in order to investigate the amount of active material dropped out from the positive electrode, a part of the set of electrodes was disassembled after fabrication to take out the positive electrode, and the loss of weight with respect to the weight before assembling it into the set of electrodes was obtained in order to investigate the amount of active material dropped out by taking the weight loss of the positive electrode A as the standard.

The charging-discharging characteristics test results for each of the batteries are shown in Table 1. Table 1 reads that battery A obtained in Embodiment 1 yields a high positive electrode utilization factor well comparable to that of battery C. On the other hand, it can be understood that battery B yields a lower positive electrode utilization factor as compared with battery A or battery C.

TABLE 1

| | Positive electrode utilization factor (%) | | |
|---|---|---|---|
| | 0.2 hour rate | 1 hour rate | 2 hour rate |
| Battery A | 101 | 94 | 87 |
| Battery B | 98 | 90 | 82 |
| Battery C | 100 | 93 | 88 |

FIGS. 1 to 3 show the cross section view of the positive electrodes A, B, and C, respectively. As shown in FIGS. 1 and 3, positive electrode A and positive electrode C contain nickel hydroxide coated in advance by COH, and this assures electric conductivity leading to a high utilization factor.

In contrast to the above, the positive electrode B contains COH only as an additive. Hence, it is presumed that COH is insufficiently dispersed, and that the utilization factor becomes relatively low.

Then, the amount of active material dropped out in each of the batteries is shown in Table 2. The amount dropped out is normalized by taking the amount dropped out of positive electrode A as 1.0 and expressing the amounts in ratios.

It can be understood that the amount dropped out is lower for positive electrode A as compared with those of positive electrodes B and C.

As shown in FIG. 3, the active materials in positive electrode C are adhered with each other by the binder, but large amount is dropped out because the effect of suppressing the drop out of the active material is insufficient.

As shown in FIG. 2, in positive electrode B, not only the binder adhere the active materials with each other, but also the active material powder particles are adhered with each other in the form of COH-active material in the form of active material-COH-active material via COH incorporated as the additive agent, thereby enhancing the adhesion and suppressing drop out to some extent.

Referring to FIG. 1, in positive electrode A, in addition to the effect similar to positive electrode B, there is the effect resulting from the agglomeration of COH coating the active material with COH of the additive, because COH tends to agglomerate with each other. The effect obtained from the tendency of forming agglomeration greatly contributes to the suppression of drop out.

By these effects, positive electrode A is presumed to clearly show effect on suppressing the drop out.

TABLE 2

| | Amount dropped out |
|---|---|
| | (relative value) |
| Positive electrode A | 1.0 |
| Positive electrode B | 1.3 |
| Positive electrode C | 1.4 |

As described above, by the present embodiment, a positive electrode having little drop out can be obtained while maintaining utilization factor.

### Embodiment 2

In the present embodiment, an example of producing an alkaline storage battery using a positive electrode plate, which was prepared by changing particle size of COH powder used as the additive, is described. A positive electrode plate and a battery were manufactured in the same manner as in Embodiment 1, except for changing the particle diameter of COH powder used as the additive.

The average particle diameter of COH powders thus prepared was 2.1, 5.0, 7.6, 10.2, and 15.4 μm, respectively.

The utilization factor for positive electrode was measured under conditions similar to those of Embodiment 1 on each of the batteries thus manufactured. The measured results are shown in Table 3. From Table 3, it can be understood that high utilization factor is achieved irrespective of the particle diameter of COH powder used as the additive. Presumably, electric conductivity is assured by COH coating.

TABLE 3

| Particle diameter of | Positive electrode utilization factor (%) | | |
|---|---|---|---|
| COH additive (μm) | 0.2 hour rate | 1 hour rate | 2 hour rate |
| 2.1 | 101 | 94 | 87 |
| 5.0 | 101 | 94 | 86 |
| 7.6 | 101 | 93 | 86 |
| 10.2 | 101 | 93 | 86 |
| 15.4 | 101 | 94 | 87 |

Then, the amount dropped out from electrode plate was investigated by a method similar to that of Embodiment 1. The measured results are given in Table 4.

TABLE 4

| Particle diameter of | Amount dropped out |
|---|---|
| COH additive (μm) | (relative value) |
| 2.1 | 1.0 |
| 5.0 | 1.1 |
| 7.6 | 1.2 |
| 10.2 | 1.4 |
| 15.4 | 1.4 |

From Table 4, it can be understood that the amount dropped out is suppressed low in case the particle diameter of COH additive, i.e., the particle diameter of nickel hydroxide powder coated by COH, is smaller than 10.2 μm. That is, in case the average particle diameter of nickel hydroxide powder coated by COH is larger than the average particle diameter of the additive made of COH powder, the amount dropped out is suppressed to a low value.

In case the average particle diameter of nickel hydroxide powder coated by COH is larger than the average particle diameter of the additive made of COH powder, the binder effect on adhering the COH-coated active materials with each other is exhibited.

The drop out can be prevented from occurring by enhancing adhesion among the powder particles via the additive COH, in the form of active material-additive, i.e., COH-active material.

Furthermore, because COH is apt to agglomerate with each other, COH coating the active material tends to agglomerate with COH of the additive to greatly contribute to the suppression of drop out. It is presumed that the effect of drop out suppression clearly appears from these effects.

In case the average particle diameter of nickel hydroxide powder coated by COH is smaller than the average particle diameter of the additive made of COH powder, the number of COH particles decreases relatively as to weaken the adhesion among the powder particles that is realized in the form of COH-active material.

As described above, by setting the average particle diameter of nickel hydroxide powder coated by COH larger than the average particle diameter of the additive made of COH powder, it is possible to obtain a positive electrode having small drop out, while maintaining the high utilization factor.

### Embodiment 3

In embodiment 3, the weight of COH coating was changed in nickel hydroxide powder coated by COH. An alkaline storage battery produced by using the thus obtained positive electrode plate is described.

Positive electrode plates and batteries were produced in the same manner as in Embodiment 1, except for changing the weight of the coating COH.

The coverage of COH in nickel hydroxide powder coated by COH was 1, 3, 5, 10, and 12%, respectively, with respect to the total weight of nickel hydroxide. The average particle sizes of COH-coated nickel hydroxide powder thus prepared were 10.1, 10.2, 10.3, 10.5, and 10.6 μm, respectively.

The utilization factor for positive electrode was measured under conditions similar to those of Embodiment 1 on each of the batteries thus manufactured. The measured results are shown in Table 5.

From Table 5, it can be understood that electric conductivity is achieved by COH coating in each of the cases to show high utilization factor. In case the coverage of COH is 3% or higher, presumably, a sufficiently high electric conductivity is achieved to yield particularly high utilization factor.

TABLE 5

| | Positive electrode utilization factor (%) | | |
|---|---|---|---|
| COH coverage (wt. %) | 0.2 hour rate | 1 hour rate | 2 hour rate |
| 1 | 100 | 92 | 84 |
| 3 | 100 | 93 | 86 |
| 5 | 101 | 94 | 87 |
| 10 | 101 | 94 | 87 |
| 12 | 101 | 94 | 87 |

Then, the amount dropped out from electrode plate was investigated by a method similar to that of Embodiment 1. The measured results are given in Table 6.

TABLE 6

| | Amount dropped out |
|---|---|
| COH coverage (wt. %) | (relative value) |
| 1 | 1.0 |
| 3 | 1.0 |
| 5 | 1.0 |
| 10 | 1.1 |
| 12 | 1.2 |

From Table 6, it can be understood that the amount dropped out is generally suppressed low. Among them, the amount dropped out is particularly low in case COH coverage is 10% or lower.

In case COH coverage is 10% or lower, great effect is found on the binder which adheres COH-coated active material with each other. The drop out can be prevented from occurring by enhancing adhesion among the powder particles via COH used as the additive in the form of active material-additive, i.e., COH-active material. Furthermore, because COH tends to agglomerate with each other, COH coating the active material tends to agglomerate with COH powder in the additive to greatly contribute to the suppression of drop out. It is presumed that the effect of drop out suppression clearly appears from these effects.

In general, in case the amount of cobalt hydroxide that coats nickel hydroxide powder increases, the coating layer tends to peel off. Accordingly, COH layer of nickel hydroxide powder coated by COH, which is produced from nickel hydroxide powder covered by this cobalt hydroxide, also tends to be peeled off. In case the coverage of COH is 10% or lower, the peeling off of COH layer is so small that the effect of suppressing drop out is clearly exhibited.

As described above, in order to obtain a positive electrode having particularly low drop out while maintaining high utilization factor, it is strongly preferred that COH coating nickel hydroxide powder accounts for 3 to 10% of the weight of nickel hydroxide.

### Embodiment 4

In embodiment 4, the amount of COH added as an additive (the weight ratio of additive made of COH with respect to the weight of nickel hydroxide in nickel hydroxide powder coated by COH) was changed to prepare a positive electrode plate. An example of an alkaline storage battery produced by using the thus obtained positive electrode plate is described.

Positive electrode plates and batteries were produced in the same manner as in Embodiment 1, except for changing the weight of COH powder added as an additive.

The utilization factor for batteries was measured under conditions similar to those of Embodiment 1 on each of the batteries thus manufactured. The measured results are shown in Table 7.

TABLE 7

| Amount of added COH | Positive electrode utilization factor (%) | | |
|---|---|---|---|
| (wt. %) | 0.2 hour rate | 1 hour rate | 2 hour rate |
| 0.5 | 100 | 92 | 86 |
| 1 | 100 | 93 | 86 |
| 2 | 101 | 94 | 87 |
| 5 | 101 | 94 | 87 |
| 10 | 101 | 94 | 87 |

From table 7, it can be understood that high utilization factor is achieved irrespective of the amount of COH added as an additive. This is because, presumably, electric conductivity is established by the coated COH.

Then, the amount dropped out from electrode plate was investigated by a method similar to that of Embodiment 1. The measured results are given in Table 8.

From Table 8, it can be understood that the amount dropped out is generally suppressed low.

Among them, the amount dropped out is particularly low in case the amount of added COH powder is in the range of 1 to 5%.

TABLE 8

| Amount of added COH | Amount dropped out |
|---|---|
| (wt. %) | (relative value) |
| 0.5 | 1.2 |
| 1 | 1.0 |
| 2 | 1.0 |
| 5 | 1.1 |
| 10 | 1.2 |

In case the amount of added COH powder is 1 to 5%, the binder which adheres the COH-coated active materials together is highly effective. The drop out can be prevented from occurring by enhancing adhesion among the powder particles via the additive COH powder, in the form of active material-additive, i.e., COH-active material. Furthermore, because COH tends to agglomerate with each other, COH coating the active material is likely to agglomerate with COH powder in the additive to greatly contribute to the suppression of drop out. It is presumed that the effect of drop out suppression clearly appears from these effects.

Because a binder is used to adhere the additive COH with each other, higher addition of COH not always results in a higher suppression of drop out. The adhesion among the active materials coated by COH and the adhesion of active material with additives via COH powder added as the additive, i.e., the adhesion in the form of COH-active material, should both work effectively. As a result, it is presumed that an optimum amount of addition is achieved at an amount of added COH of 1 to 5%, and the effect of the present invention is greatly exhibited.

As described above, in order to obtain positive electrode particularly reduced in drop out while maintaining high utilization factor, it is extremely preferred that the amount of COH powder added as an additive is in a range of 1 to 5%.

### Embodiment 5

In embodiment 5, the particle diameter of nickel hydroxide powder coated by COH (sometimes referenced as “COH-coated nickel hydroxide powder” hereinafter) and the particle diameter of COH powder added as an additive were changed to prepare a positive electrode plate. An example of an alkaline storage battery produced by using the thus obtained positive electrode plate is described. The positive electrode plate and the battery were prepared in the same manner as in Embodiment 1 except for changing the particle diameter of COH-coated nickel hydroxide powder and of COH powder added as an additive.

The average particle size of each of the COH-coated nickel hydroxide powders thus prepared was 4.9, 7.0, 10.2, 15.0, and 18.3 μm, respectively.

The average particle size of each of the COH powder thus prepared was 0.1, 0.5, 2.1, 5.0, and 7.6 μm, respectively.

The utilization factor for positive electrode was measured under conditions similar to those of Embodiment 1 on each of the batteries thus manufactured. The utilization factors at 2-hour rate discharge are shown in Table 9.

TABLE 9

| | | Particle diameter of nickel hydroxide powder (μm) | | | | |
|---|---|---|---|---|---|---|
| | | 4.9 | 7.0 | 10.2 | 15.0 | 18.3 |
| Particle | 0.1 | 87 | 87 | 87 | 87 | 87 |
| diameter | 0.5 | 87 | 87 | 87 | 87 | 87 |
| of COH | 2.1 | 86 | 87 | 87 | 87 | 87 |
| (μm) | 5.0 | 86 | 86 | 86 | 87 | 87 |
| | 7.6 | 86 | 86 | 86 | 86 | 86 |

From Table 9, it can be understood that high utilization factor is achieved irrespective of the particle diameter of COH-coated nickel hydroxide powder and of COH powder added as an additive. This is because, presumably, electric conductivity can be established by the coated COH.

Then, the amount dropped out from electrode plate was investigated by a method similar to that of Embodiment 1. The measured results are given in relative values in Table 10.

From Table 10, it can be understood that the amount dropped out is suppressed low except for the cases in which the particle diameter of COH powder is not smaller than the particle diameter of nickel hydroxide powder coated by COH.

TABLE 10

| | | Particle diameter of nickel hydroxide powder (μm) | | | | |
|---|---|---|---|---|---|---|
| | | 4.9 | 7.0 | 10.2 | 15.0 | 18.3 |
| Particle | 0.1 | 1.2 | 1.2 | 1.2 | 1.2 | 1.2 |
| diameter | 0.5 | 1.2 | 1.1 | 1.0 | 1.1 | 1.2 |
| of COH | 2.1 | 1.2 | 1.0 | 1.0 | 1.0 | 1.2 |
| (μm) | 5.0 | 1.3 | 1.1 | 1.1 | 1.1 | 1.2 |
| | 7.6 | 1.4 | 1.3 | 1.2 | 1.2 | 1.2 |

Furthermore, the amount dropped out is suppressed to particularly low value in case the particle diameter of nickel hydroxide coated by COH is in a range of 7.0 to 15.0 μm and the particle diameter of COH powder is in a range of 0.5 to 5.0 μm.

Because the powder particles are more strongly adhered to each other via the additive COH powder, in the form of active material-additive, i.e., COH-active material, drop outs are suppressed.

Furthermore, because COH tends to agglomerate with each other, COH coating the active material tends to agglomerate with COH powder in the additive to greatly contribute to the suppression of drop out. It is presumed that the effect of drop out suppression clearly appears from these effects.

The above effects differ depending on the difference in particle diameters of nickel hydroxide coated by COH and COH powder used as the additive, the amount of binder used to adhere the powder particles of COH, which is an additive differing in particle size, and the interstices which form among the particles of nickel hydroxide powder coated by COH.

By the present invention, it has been clarified that the great effect can be exhibited in case the particle diameter of nickel hydroxide powder coated by COH is in a range of 7.0 to 15.0 μm and the particle diameter of COH powder is in a range of 0.5 to 5.0 μm.

As described above, in order to obtain positive electrode particularly reduced in drop out while maintaining high utilization factor, it is extremely preferred that the particle diameter of nickel hydroxide powder coated by COH is set in a range of 7.0 to 15.0 μm and the particle diameter of COH powder is set in a range of 0.5 to 5.0 am.

### Embodiment 6

In embodiment 6, non-spherical (amorphous) nickel hydroxide particles were produced by changing the conditions for preparing nickel hydroxide powder.

Then, a positive electrode plate was fabricated by using the nickel hydroxide powder, and an alkaline storage battery was produced using the positive electrode plate, which is described below. The positive electrode plate and the battery were prepared in the same manner as in Embodiment 1, Comparative Example 1, and Comparative Example 2, except for changing nickel hydroxide particles into non-spherical particles. The positive electrode plates thus fabricated were each denoted as positive electrode D, positive electrode E, and positive electrode F, respectively, and the batteries produced therefrom were each denoted as battery D, battery E, and battery F, respectively. However, since the packing density decreases for non-spherical nickel hydroxide particles when compared with spherical particles, the nominal capacity for batteries D, E, and F is 800 mAh.

The average particle diameter of nickel hydroxide powder coated by COH used for positive electrode D was 10.1 μm, and the average particle diameter of COH particles was 2.1 μm. The average particle diameter of nickel hydroxide powder used in positive electrode E was 10.0 μm. The average particle diameter of nickel hydroxide powder coated by COH used for positive electrode F was 10.2 μm.

The utilization factor for positive electrode was measured under conditions similar to those of Embodiment 1 on each of the batteries thus manufactured. The measured results are given in Table 11.

TABLE 11

| | Positive electrode utilization factor (%) | | |
|---|---|---|---|
| | 0.2 hour rate | 1 hour rate | 2 hour rate |
| Battery D | 100 | 92 | 86 |
| Battery E | 97 | 90 | 81 |
| Battery F | 99 | 92 | 86 |

From Table 11, it can be understood that battery D and battery F show high positive electrode utilization factor. Since nickel hydroxide is coated by COH in advance in positive electrodes D and F according to the embodiments, presumably, electric conductivity can be established to show high utilization factor.

In contrast to above, battery E shows relatively low utilization factor. In positive electrode E, COH is only added as an additive. As a result, it is presumed that COH is insufficiently dispersed and that this has lead to a relatively low utilization factor.

Then, the amounts of active material dropped out from each of the batteries are shown in Table 12.

TABLE 12

| | Amount dropped out |
|---|---|
| | (relative value) |
| Positive electrode D | 1.0 |
| Positive electrode E | 1.2 |
| Positive electrode F | 1.3 |

The values here are normalized by taking positive electrode D according to the embodiment as the standard. It can be understood that the amount dropped out is suppressed low for positive electrode D as compared with positive electrodes E and F.

In positive electrode F, the active materials are adhered with each other by the binder; however, the amount dropped out is large because the effect on suppressing the drop out of active material is insufficient.

In positive electrode E, the drop out is suppressed to some extent, because not only the binder adheres the active materials with each other, but also the powder particles are more strongly adhered with each other via the additive COH, in the form of active material-additive, i.e., COH-active material.

In positive electrode D, in addition to the effect similar to positive electrode E, COH is apt to agglomerate with each other; hence, COH coating the active material tends to agglomerate with COH powder in the additive and it greatly contributes to the suppression of drop out. By these effects, drop-out suppression effect distinctly appears on positive electrode D.

The results of Table 2 obtained by using spherical nickel hydroxide are compared with the results of Table 12 obtained by using non-spherical nickel hydroxide to compare the effect of the embodiment on suppressing drop out with that of comparative example. The effect is expressed by the difference in relative value between embodiment and comparative example.

Large difference in relative value means the effect is high. In case non-spherical nickel hydroxide (shown in Table 12) is used, the improvement is in the range of 0.2-0.3, which is in distinct contrast to the case of 0.3-0.4 using spherical nickel hydroxide (shown in FIG. 2). The effect of the present invention is particularly high.

In general, because of their shapes, spherical nickel hydroxide particles weakly interact with each other, and they tend to flow and cause drop outs. Thus, the effect of the present invention on improving suppression of drop outs appear particularly pronounced.

As described above, the constitution according to the present invention provides a positive electrode having small drop outs while maintaining high utilization factor. Moreover, the effect of suppressing drop outs is particularly maximized by using spherical nickel hydroxide powder coated by COH as compared with the case using non-spherical ones.

By employing the above constitution, the additive made of COH powder intrudes into the interstices among nickel hydroxide powder coated by COH. Then, adhesion of nickel hydroxide powder coated by the binder COH, and adhesion via COH powder, i.e., in the form of COH-coated nickel hydroxide powder-COH powder-adhesion nickel hydroxide coated by COH and additive, can be observed.

That is, in addition to direct adhesion of active materials, adhesion of active materials via an additive is realized.

Furthermore, nickel hydroxide powder coated by COH and COH as the additive are both particles whose surface is constituted by COH.

COH above has great tendency for agglomeration, and this strong agglomeration force greatly contributes to the prevention of drop out of active material powder and the like. More specifically, by utilizing conjointly the nickel hydroxide powder coated by COH and the additive made of COH powder having smaller average particle diameter, the adhesion effect is more clearly exhibited.

As described in the background of the invention, COH having tendency for agglomeration makes it difficult to disperse COH.

The non-sintered type positive electrode of the present invention can be widely used for alkaline storage batteries.

1. A non-sintered type positive electrode for alkaline storage battery comprising:
an electrically conductive support;
a nickel hydroxide powder coated by cobalt oxyhydroxide;
an additive made of cobalt oxyhydroxide powder; and
a binder, wherein
the average particle diameter of the nickel hydroxide powder coated by cobalt oxyhydroxide is greater than that of the additive made of cobalt oxyhydroxide.

2. A non-sintered type positive electrode for alkaline storage battery according to claim 1, wherein, in the nickel hydroxide powder coated by cobalt oxyhydroxide, the amount of added cobalt oxyhydroxide coating accounts for 3 to 10% of the weight of nickel hydroxide.

3. A non-sintered type positive electrode for alkaline storage battery according to claim 1, wherein the amount of added additive made of cobalt oxyhydroxide powder accounts for 1 to 5% of the weight of nickel hydroxide constituting the nickel hydroxide powder coated by cobalt oxyhydroxide.

4. A non-sintered type positive electrode for alkaline storage battery according to claim 1, wherein the average particle diameter of the nickel hydroxide powder coated by cobalt oxyhydroxide is in the range of 7 to 15 μm, and the average particle diameter of the additive made of cobalt oxyhydroxide powder is in a range of 0.5 to 5 μm.

5. A non-sintered type positive electrode for alkaline storage battery according to claim 1, wherein the shape of the nickel hydroxide powder coated by cobalt oxyhydroxide is spherical.

6. An alkaline storage battery comprising:
a negative electrode;
a separator;
an alkaline electrolytic solution; and
a non-sintered type positive electrode, wherein
the non-sintered type positive electrode comprising:
an electrically conductive support;
a nickel hydroxide powder coated by cobalt oxyhydroxide;
an additive made of cobalt oxyhydroxide powder; and
a binder, wherein the average particle diameter of the nickel hydroxide powder coated by cobalt oxyhydroxide is greater than that of the additive made of cobalt oxyhydroxide.

7. An alkaline storage battery according to claim 6, wherein, in the nickel hydroxide powder coated by cobalt oxyhydroxide, the amount of added cobalt oxyhydroxide coating accounts for 3 to 10% of the weight of nickel hydroxide.

8. An alkaline storage battery according to claim 6, wherein the amount of added additive made of cobalt oxyhydroxide powder accounts for 1 to 5% of the weight of nickel hydroxide constituting the nickel hydroxide powder coated by cobalt oxyhydroxide.

9. An alkaline storage battery according to claim 6, wherein the average particle diameter of the nickel hydroxide powder coated by cobalt oxyhydroxide is in the range of 7 to 15 μm, and the average particle diameter of the additive made of cobalt oxyhydroxide powder is in a range of 0.5 to 5 μm.

10. An alkaline storage battery according to claim 6, wherein the shape of the nickel hydroxide powder coated by cobalt oxyhydroxide is spherical.
